(19) United States
(12) Patent Application Publication
(10) Pub. No.: US 2016/0012526 A1
(43) Pub. Date: Jan. 14, 2016

(54) ACCOUNT SECURITY VIA AN ELECTRONIC TOKEN

(71) Applicant: PAYPAL, INC., San Jose, CA (US)

(72) Inventors: Stephane Kasriel, Los Altos, CA (US); Bonnie Sherman, San Jose, CA (US)

(21) Appl. No.: 14/852,337

(22) Filed: Sep. 11, 2015

Related U.S. Application Data
(63) Continuation of application No. 13/033,296, filed on Feb. 23, 2011.
(60) Provisional application No. 61/390,384, filed on Oct. 6, 2010.

(51) Int. Cl. G06Q 40/00; G06Q 30/04

(52) U.S. Cl. CPC G06Q 40/00; G06Q 30/04

(57) ABSTRACT

In accordance with one or more embodiments of the present disclosure, a device is configured to capture data using an image sensor, decode the data to identify a unique electronic token providing access to a database, process the unique electronic token, access the database and retrieve information associated with an account corresponding to the unique electronic token, generate an electronic user interface displaying the information, and in response to receiving, via the electronic user interface, login information associated with the account, provide access to the account.

### CROSS REFERENCE TO RELATED APPLICATIONS

This application claims priority to U.S. patent application Ser. No. 13/033,296 filed on Feb. 23, 2011 and U.S. Provisional Patent Application Ser. No. 61/390,384, filed Oct. 6, 2010, which are incorporated by reference in their entirety.

### BACKGROUND

1. Technical Field

The present invention generally relates to facilitating electronic commerce over a network and, more particularly, to facilitating payment reconciliation over a network.

2. Related Art

In online financial transactions, users search for and purchase products and services through electronic communications with online merchants over electronic networks, such as the Internet. During the course of these purchase transactions, users may provide payment to a transaction service provider in various ways including, for example, credit cards, electronic fund transfers, and other payment techniques offered by the service providers.

Typically, when shopping at a particular website, users select items to purchase by clicking on a link for a specific item. The selected items are placed on reserve in some type of virtual shopping cart. When done shopping, the user is directed to checkout and provide some form of payment for the selected items.

At this point in the process, the user may request deferment of payment. When this happens, the shopping cart and any reserved items may be cancelled for failure to make payment in a timely manner. As such, this usually results in lost revenue for the online merchant and the payment service provider.

Thus, there currently exists a need to improve the process of handling deferred payments in online purchase transactions.

### SUMMARY

Embodiments of the present disclosure relate to systems and methods for facilitating electronic commerce over a network including facilitating invoice payment reconciliation over the network. In one embodiment, invoice payment reconciliation includes automating invoice payments for printed invoices received via a postal delivery service. The printed invoices may include one or more of an invoice uniform resource locator (URL) and/or an invoice identifier code (e.g., barcode) that may be printed on the printed invoice to identify the invoice. The invoice URL and/or invoice identifier code may be adapted to encode the contents of the invoice and/or a reference that maps to the contents of the invoice stored on a network server operated by a network based payment service provider.

In one implementation, the user or payer of the invoice utilizes a user device with a code reader (e.g., a mobile phone with a camera) to capture an image of the invoice URL and/or invoice identifier code. The user device utilizes a user interface application adapted to fetch payment information (e.g., invoice description, amount due, due date, payer account, etc.) related to the invoice URL and/or invoice identifier code from the network server operated by the network based payment service provider. After fetching the invoice related information, the user interface application displays the invoice information to the payer via the user device. The user or payer may choose to pay the invoice immediately or schedule invoice payment, choose how to fund the invoice payment (e.g., payer account, other bank account, credit card, debit card, etc.), and choose to confirm payment. Advantageously, the user or payer may pay multiple invoices in this manner in just a few minutes using a mobile phone, and the user or payer may achieve an experience that is faster and less error prone than conventional check writing methods.

Embodiments of the present disclosure provide systems and methods for facilitating electronic commerce including facilitating payment reconciliation over a network. In one embodiment, the system and method includes communicating with a user via a user device and a merchant via a merchant device over the network, receiving a purchase request from the merchant via the merchant device over the network on behalf of the user, generating an invoice with an invoice identifier related to the purchase request, printing the generated invoice with the invoice identifier, sending the printed invoice with the invoice identifier to the user via a postal service, receiving an invoice payment request from the user via the user device over the network, obtaining the invoice identifier from the invoice payment request, reconciling an invoice payment on behalf of the user via the user device over the network, and storing information related to the reconciled invoice payment.

In one implementation, the invoice identifier comprises a uniform resource locator (URL) link, and the URL link comprises information related to the invoice. IN another implementation, the invoice identifier comprises a invoice identifier code, the invoice identifier code comprises a barcode, and the invoice identifier code comprises information related to the invoice. The invoice is sent to an address of the user via a postal delivery service. The invoice identifier is obtained from an image of the printed invoice, the image is captured by the user with a digital camera, and the image of the invoice identifier is received as part of the invoice payment request from the user via the user device over the network.

In various implementation, reconciling the payment includes receiving electronic payment for debt settlement of the invoice. The system and method may include notifying the user of the invoice as an invoice pending payment via the user device over the network, wherein notifying the user includes sending a notification to the user device over the network including at least one of an email, an alert, a text message, and a voice message. The system and method may include prompting the user to login over the network after receiving the invoice payment request from the user via the user device over the network, receiving user information including user identity information from the user via the user device over the network, verifying the identity of the user based on the user information passed with the login request, and accessing an account related to the user based on the verified user identity.

These and other aspects of the present disclosure will be more readily apparent from the detailed description of the embodiments set forth below taken in conjunction with the accompanying drawings.

### BRIEF DESCRIPTION OF THE DRAWINGS

FIG. 1 shows a block diagram of a system adapted to facilitate electronic commerce over a network, in accordance with one or more embodiments of the present disclosure.

FIGS. 2-5 show various methods for facilitating electronic commerce over a network, in accordance with one or more embodiments of the present disclosure.

FIG. 6 is a block diagram of a computer system suitable for implementing one or more embodiments of the present disclosure.

Embodiments of the invention and their advantages are best understood by referring to the detailed description that follows. It should be appreciated that like reference numerals are used to identify like elements illustrated in one or more of the figures, wherein showings therein are for purposes of illustrating embodiments of the invention and not for purposes of limiting the same.

### DETAILED DESCRIPTION

Embodiments of the present disclosure provide systems and methods for facilitating electronic commerce over a network including invoice payment reconciliation.

In one embodiment, invoice payment reconciliation may include automating invoice payments for printed invoices received via a mail delivery service. The printed invoices may include, as part thereof, one or more of an invoice uniform resource locator (URL) and/or an invoice identifier code (e.g., 1D barcode, 2D barcode, or some other encoding mechanism) that is printed on the printed invoice to identify the invoice. In one aspect, the invoice URL and/or invoice identifier code may be adapted to encode the contents of the invoice and/or a reference that maps to the contents of the invoice stored on a network server operated by a network based payment service provider.

In one implementation, the user or payer of the invoice utilizes a user device, such as mobile phone, with an integrated code reader, such as a digital camera, to capture an image of the invoice URL and/or invoice identifier code. The user device utilizes a user interface application adapted to fetch payment information (e.g., invoice description, amount due, due date, payer account, etc.) related to the invoice URL and/or invoice identifier code from the network server operated by the network based payment service provider. However, in another implementation, the invoice URL and/or invoice identifier code may encode the invoice information itself. After fetching the invoice related information, the user interface application displays the invoice information to the payer via the user device. The user or payer may choose to pay the invoice immediately or schedule invoice payment, choose how to fund the invoice payment (e.g., payer account, other bank account, credit card, debit card, etc.), and choose to confirm payment. The user or payer may pay multiple invoices in this manner in just a few minutes using a mobile phone, and the user or payer may achieve an experience that is faster and less error prone than conventional check writing methods.

According to another embodiment of the present disclosure, a merchant may generate an invoice on an invoicing site of an online service provider. As part of generating the invoice, a URL or code (e.g., a 2D barcode) is generated that includes a link via a unique token to a network database that stores the invoice information or a unique code that holds the invoice information (e.g., merchant, payer, addresses, amount, item details, etc.). The merchant or the service provider may print the invoice and mail the printed invoice to the user or payer via a postal mail delivery service. The printed invoice includes, as part thereof, the invoice identifier code (e.g., a 2D barcode or some other encoding mechanism). These and other aspects of the present disclosure are described in greater detail herein.

According to another embodiment of the present disclosure, a payer may receive the printed invoice in the mail. The payer may choose to pay the invoice electronically via the user device, such as a mobile phone. The payer may capture an image (e.g., take a picture) of the invoice identifier code (e.g., a 2D barcode or some other encoding mechanism) with a camera integrated as part of the mobile phone. The user interface application of the mobile phone is adapted to decode the invoice information from the invoice identifier code or fetch the invoice information related to the invoice identifier code from the network database. The user interface application is adapted to display the invoice with invoice details on a display component of the mobile phone, in a manner as originally entered by the merchant. The payer may choose pay the invoice via their mobile phone or take another image of another invoice and pay multiple invoices at the same time. As such, in various aspects, the payer may not have to manually input invoice information, the payer may pay multiple invoices electronically, which faster than payment by conventional check, and the payer may track invoice details and invoice payments over the network via the service provider. These and other aspects of the present disclosure are described in greater detail herein.

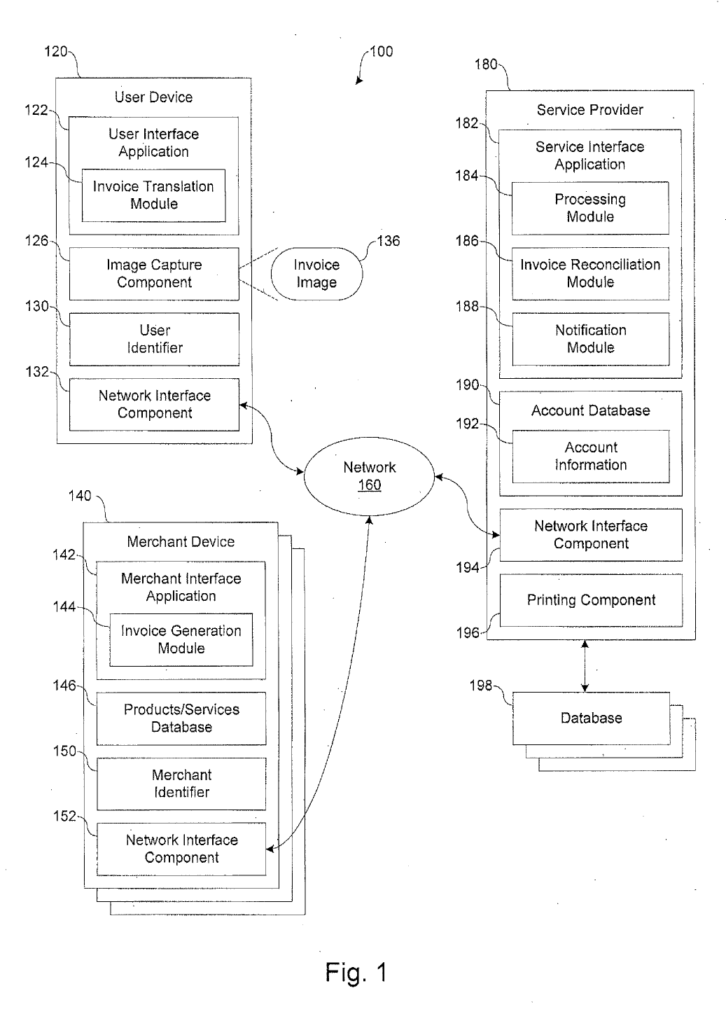

FIG. 1 shows one embodiment of a system 100 for facilitating electronic commerce including facilitating payment reconciliation, over a network 160, such as the Internet and/or a mobile communication network. As shown in FIG. 1, the system 100 includes a user device 120 (e.g., a client device or customer device) adapted to interface with one or more merchant devices 140 (e.g., business entities proffering items, products, and/or services for purchase), and a service provider 160 (e.g., a network based transaction service provider, such as a payment, settlement, and reconciliation transaction provider) over the network 160.

The network 160, in one embodiment, may be implemented as a single network or a combination of multiple networks. For example, the network 160 may include a wireless communications network (e.g., mobile telephone network) adapted for communication with one or more other communication networks, such as the Internet. In other examples, the network 160 may include the Internet, one or more intranets, landline networks, wireless networks, and/or one or more other appropriate types of communication networks. As such, in various implementations, the user device 120, the one or more merchant devices 140, and the service provider 180 may be associated with a particular link (e.g., a link, such as a URL (Uniform Resource Locator) to an IP (Internet Protocol) address).

The user device 120, in various embodiments, may be implemented using any appropriate combination of hardware and/or software configured for wired and/or wireless communication over the network 160. In one embodiment, the user device 120 may be implemented as a mobile communication device (e.g., wireless cellular phone) adapted for communication with the network 160. In other embodiments, the user device 120 may be implemented as a personal computer (PC), a personal digital assistant (PDA), a notebook computer, a laptop computer, and/or various other generally known types of wired and/or wireless computing devices for communication with the network 160. It should be appreciated that the user device 120 may be referred to as a client device or a customer device without departing from the scope of the present disclosure.

The user device 120, in one embodiment, includes a user interface application 122 having an invoice translation module 124, which may be utilized by a user to conduct network based financial transactions (e.g., remote network based electronic commerce including invoice payment reconciliation) with one or more merchant devices 140 and/or the service provider 180 over the network 160. In various implementations, the user interface application 122 may be implemented as an online network commerce application and/or a mobile commerce application to initiate, track, manage, and store data and information related to remote network based electronic commerce for viewing, searching, and/or purchasing items, products, and/or services over the network 160. In one aspect, the user device 120 may be linked to an account with the service provider 160 for direct and/or automatic settlement of purchase requests and/or invoices between a user, the one or more merchant devices 140, and/or the service provider 180 via the user interface application 122 and/or the invoice translation module 124, which is described in greater detail herein.

In one embodiment, the user interface application 122 comprises a software program, such as a graphical user interface (GUI), executable by a processor that is configured to interface and communicate with the one or more merchant devices 140 and/or the service provider 180 via the network 160. In one implementation, the user interface application 122 comprises a browser module adapted to provide a network interface to browse information available over the network 160. For example, the user interface application 122 may be implemented, in part, as a web browser to view and search information available over the network 160. In another example, the user is able to access merchant websites of the one or more merchant devices 140 over the network 160 to view, search, and select items, products, and/or services for purchase, and the user is able to purchase selected items, products, and/or services from the one or more merchant devices 140 via the service provider 180. As such, the user may conduct network based financial transactions (e.g., online electronic commerce including purchasing and/or invoice payment reconciliation) with the one or more merchant devices 140 via the service provider 180.

In one embodiment, upon user instruction, the user interface application 122 may be installed and/or run on the user device 120. The user may run the user interface application 122 on the user device 120 to access the service provider 180 via the network 160. In one aspect, upon installation and/or execution of the user interface application 122, the user may be prompted to establish a user account for login with the service provider 180, wherein the user may use the user interface application 122 and the user device 120 to access the service provider 180 via the network 160. When establishing a user account, the user may be asked to provide personal information, such as name, address, phone number, etc., and financial information, such as banking information, credit card information, etc. In another aspect, referring to FIG. 1, information related to the user may be packaged as a user identifier 130, which is described in greater detail herein.

The user device 120, in one embodiment, may include an image capture component 126 (e.g., a digital camera) adapted to interface with the user interface application 122 and the invoice translation module 124 to capture, store, and utilize one or more images, such as image 136 of an invoice identifier (e.g., a code that identifies a particular invoice, which may include a bar code, URL, or some other encoded identifier). The image capture component 126 may represent any type of digital camera, which for example detects visible light and provides representative data (e.g., picture data, snapshot data, digital image data, etc.). The image capture component 126 may comprise a portable imaging device and be incorporated into the user device 120 (e.g., a mobile phone, portable computer, laptop computer, etc.). In one implementation, the user device 120 operates as a mobile phone with the image capture component 126 (e.g., a digital camera) integrated as part thereof and/or in communication with the network 160.

The image capture component 126 comprises, in one embodiment, visible light sensors for capturing image signals representative of an image, such as image 136 (e.g., an image of an invoice and/or invoice identifier). In one example, the visible light sensors of the image capture component 126 provide for representing (e.g., converting) the captured image signal as digital data and/or information. It should be appreciated that image 136 may comprise any type of image including an image representing a particular invoice and/or an invoice identifier including an invoice identifier code, such as bar code or URL, associated with a particular invoice generated by at least one of the merchants 140 and/or the service provider 180. In one aspect, the user device 120 comprises a processing component adapted to convert the captured infrared image signals into image data and information, store the image data and information in a memory component, and retrieve stored image data and information from the memory component. The processing component is adapted to process image data and information stored in the memory component, and the image data and information may include captured image data and information and/or processed image data and information. In one aspect, the processing component is adapted to utilize the invoice translation module 124 to analyze the image data and information to identify and obtain the invoice identifier code. These and other aspects of the image capture component 126, the invoice identifier, and the invoice identifier code are described in greater detail herein.

The user device 120, in various embodiments, may include other applications as may be desired in one or more embodiments of the present disclosure to provide additional features available to the user. In various examples, such other applications may include security applications for implementing user-side security features, programmatic client applications for interfacing with appropriate application programming interfaces (APIs) over the network 160, and/or various other types of generally known programs and/or software applications. In various other examples, other applications may interface with the user interface application 122 for improved efficiency and convenience. In one example, files, data, and/or information may be imported from various types of accounting software (e.g., a spreadsheet application) directly into the user interface application 122 for improved tracking of payments, settlements, and/or reconciliations related to purchases and/or invoices via the network 160. It should be appreciated that the user interface application 122 and each of the other applications are adapted to make API calls over the network 160.

The user device 120, in various embodiments, may include the user identifier 130, which may be implemented as operating system registry entries, cookies associated with the user interface application 122, identifiers associated with hardware of the user device 120, and/or various other appropriate identifiers. The user identifier 130 may include one or more attributes related to the user, such as personal information related to the user (e.g., one or more user names, passwords, photograph images, biometric ids, addresses, phone numbers, etc.) and/or banking information (e.g., one or more banking institutions, credit card issuers, user account numbers, security data and information, etc.). In various implementations, the user identifier 130 may be passed with user transaction requests to the service provider 180 via the network 160, and the user identifier 130 may be utilized by the service provider 180 to associate the user with a particular user account and/or particular user invoices stored and/or maintained by the service provider 180.

The user device 120, in one embodiment, may include a network interface component (NIC) 132 adapted for communication with the network 160. In various implementations, the network interface component 132 may comprise a wireless communication component, such as a mobile cellular component, a wireless broadband component, a wireless satellite component, or various other types of wireless communication components including radio frequency (RF), microwave frequency (MWF), and/or infrared frequency (IRF) components adapted for communication with the network 160. In various other implementations, the network interface component 132 may be adapted to interface with a DSL (e.g., Digital Subscriber Line) modem, a PSTN (Public Switched Telephone Network) modem, an Ethernet device, and/or various other types of wired and/or wireless network communication devices adapted for communication with the network 160.

In one embodiment, the user device 120 may comprise a printing component to print an invoice having an invoice identifier. In various implementations, the printing component comprise various types of printers, such as an ink jet printer, a laser printer, a copy machine printer, or various other generally known printing devices.

The one or more merchant devices 140, in one embodiment, may be implemented using any appropriate combination of hardware and/or software configured for wired and/or wireless communication over the network 160. In various implementations, the merchant devices 140 may be implemented as a network server, a personal computer (PC), a personal digital assistant (PDA), a notebook computer, and/or various other generally known types of wired and/or wireless computing devices for communication with the network 160. In another implementation, the merchant device 140 may be implemented as a mobile device (e.g., a wireless cellular phone) adapted for communication with the network 160.

In another embodiment, the one or more merchant devices 140 may be maintained as one or more network servers by one or more business entities (e.g., merchant sites, resource information sites, utility sites, real estate management sites, social networking sites, etc.) offering various items, products, and/or services for purchase, payment, and invoicing, which may need registration of user identity information as part of offering the items, products, and/or services to one or more users over the network 160. As such, each of the one or more merchant devices 140 may comprise at least one network based server in communication with the network 160 having a merchant interface application 142, a products/services database 146 for presenting and identifying one or more available items, products, and/or services for purchase, and an invoice generation module 144 for invoicing via the network 160, which may be made available to the user device 120 for viewing, purchase, and invoicing by the user. In one implementation, each of the network based merchant servers may be accessible via a mobile communication device (e.g., wireless cellular phone) for management purposes. For example, in one aspect, each merchant entity may remotely access and interact with their own network based server via a mobile communication device for management purposes.

In one embodiment, each of the merchant devices 140 includes the merchant interface application 142, which may be utilized by the one or more merchant devices 140 to conduct network based financial transactions (e.g., remote network commerce, such as shopping, purchasing, bidding, invoicing, etc.) with one or more users via one or more user devices 120 and/or the service provider 180 over the network 160. For example, the merchant interface application 142 may be implemented as an electronic commerce application to initiate, track, manage, and store data and information related to remote network based commerce for the viewing, searching, purchasing, and invoicing of items, products, and/or services over the network 160. In one aspect, each merchant device 140 may be linked to an account with the service provider 160 for direct and/or automatic settlement of purchase requests and invoice reconciliation between each merchant 140, one or more users, and/or the service provider 180 via the merchant interface application 142.

In one implementation, the merchant interface application 142 comprises a software program, such as a GUI, executable by a processor configured to interface and communicate with one or more users via one or more user devices 120 and/or the service provider 180 via the network 160. In another implementation, merchant interface application 142 comprises a network interface module that makes information available to the user device 120 over the network 160 including invoice data and information. For example, the merchant interface application 142 may be implemented, in part, as a website manager to provide, list, and present information including invoice information to the user device 120 via the network 160. In another example, each merchant 140 is capable of providing one or more network based merchant websites to allow viewing, searching, and selecting of items, products, and/or services for purchase and invoicing by the user via the user device 120, and the user is able to purchase items, products, and/or services from the one or more merchant devices 140 via the merchant websites and the service provider 180.

In one implementation, the merchant interface application 142 is adapted to utilize the invoice generation module 144. For example, each of the merchants 140 may generate and track, in cooperation with the service provider 180, a purchase invoice having and an invoice identifier, such as an invoice identifier code that identifies a particular invoice, which may include a bar code, URL, or some other encoded identifier. As such, each merchant 140 is adapted to generate an invoice having an invoice identifier in reference to a particular user purchase request, send invoice information including the invoice identifier to the service provider 180, and send the invoice, in one example, to the user via the user device 120 for payment reconciliation. In another example, the invoice having the invoice identifier may be generated, printed, and sent to the user via a postal mail service, such as the United States Postal Service (USPS), United Postal Service (UPS), Federal Express (FedEx), etc. As such, each merchant device 140 may conduct financial transactions including invoice payment reconciliation with the user via the user interface application 122, the merchant interface application 142, and the service provider 180.

In another implementation, the merchant interface application 142 is adapted to utilize the invoice generation module 144 to request that an invoice be generated, printed, and sent to the user of the user device 120 by the service provider 180. The service interface application 182 of the service provider 180 is adapted to generate an invoice having an invoice identifier on behalf of the merchant 140, wherein the invoice having the invoice identifier is related to a purchase transaction between the merchant 140 and the user of the user device 120. The service interface application 182 is adapted to communicate with a printing component 196 of the service provider 180 to print the invoice having the invoice identifier. The service interface application 182 is adapted to prepare the invoice having the invoice identifier for postal delivery to the user of the user device 120. The invoice having the invoice identifier may be mailed to an address of the user (e.g., home address, business address, or some other address related to the user) by the service provider 180 via a postal delivery servicer, such as the USPS, UPS, FedEx, etc. As such, the service provider 180 is adapted to generate, print, and send an invoice having an invoice identifier to the user of the user device 120 of behalf of the merchant 140 for invoice payment reconciliation of a network based financial transaction between the user of the user device 120 and the merchant 140 in a manner as described herein.

In another embodiment, each merchant device 140 includes utilization of the invoice generation module 144, which may be utilized by the merchant interface application 142 to conduct network based invoicing for financial transactions (e.g., remote network commerce, such as shopping, purchasing, bidding, invoicing, etc.) with one or more users via one or more user devices 120 and/or the service provider 180 over the network 160. For example, in one implementation, the invoice generation module 144 may be implemented as an electronic commerce application to generate an invoice pertaining to network based financial transactions and store invoice data and information related to remote network based commerce for invoicing of items, products, and/or services over the network 160. In one aspect, each merchant device 140 may be linked to an account with the service provider 160 for direct and/or automatic invoicing of purchase requests and invoice reconciliation between each merchant 140, one or more users, and/or the service provider 180 via the merchant interface application 142.

In various implementations, the merchant interface application 142 may include a marketplace application, which may be configured to provide transaction information related to the products and/or services database 146 to the user interface application 122 of the user device 120 via the network 160. For example, the user may interact with the merchant 140 via the marketplace application through the user interface application 122 over the network 160 to search and view various items, products, and/or services available for purchase from the products/services database 146. In one implementation, the marketplace application may include a checkout module configured to facilitate online financial transactions by the user of items, products, and/or services identified by each merchant server 140 for purchase, and the checkout module may be configured to accept payment from the user over the network 160 and process the payment via interaction with the service provider 180. In one aspect, the checkout application may be adapted to operate in conjunction with the invoice generation module 144 to generate an invoice for items, products, and/or services selected for purchase by the user. As such, the invoice may be utilized by the merchants 140 to request payment from the user at a later time.

In one implementation, upon merchant instruction, the merchant interface application 142 may be installed and/or run on each merchant device 140. Each merchant may run the merchant interface application 142 on their merchant device 140 to access service provider 180 via the network 160. In one aspect, upon installation and/or execution of the merchant interface application 142, each merchant may be prompted to establish a merchant account for login with the service provider 180, wherein each merchant may use merchant interface application 142 and merchant device 140 to access the service provider 180 via the network 160. In one aspect, when establishing a merchant account, each merchant may be asked to provide business information, such as business name, address, phone number, etc., and financial information, such as banking information, credit card information, etc. In another aspect, information related to the merchant may be packaged as a merchant identifier 150, which is described in greater detail herein.

In various implementations, the merchant interface application 142 may include one or more other applications as may be desired to provide additional features available to the merchant. In various examples, such other applications may include security applications for implementing user-side security features, programmatic applications for interfacing with appropriate application programming interfaces (APIs) over the network 160, and/or various other types of generally known programs and/or software applications. In various other examples, files, data, and/or information may be imported from various types of accounting software (e.g., a spreadsheet application) directly into the merchant interface application 142 for improved tracking of payments and settlements related to electronic commerce via the network 160. As such, it should be appreciated that merchant interface application 142 and any other application may be adapted to make API calls over the network 160.

Each of the merchant devices 140, in various embodiments, may include at least one merchant identifier 150, which may be included as part of the one or more items, products, and/or services made available for purchase so that, e.g., particular items, products, and/or services are associated with particular merchant devices 140. In one implementation, the merchant identifier 150 may include one or more attributes and/or parameters related to the merchant, such as business and/or banking information. For example, the merchant identifier 150 may be passed from each particular merchant 140 to the service provider 180 when the user selects an item, product, and/or service for holding, monitoring, purchasing, and/or invoicing from each particular merchant 140. In one aspect, the merchant identifier 150 may be used by the service provider 180 to associate particular items, products, and/or services selected for purchase with a particular merchant account maintained by the service provider 180. In another aspect, the merchant identifier 150 may be used by the service provider 180 to associate particular invoices with a particular merchant account maintained by the service provider 180. In another aspect, the user may conduct financial transactions (e.g., selection, monitoring, purchasing, and/or providing payment for items, products, and/or services) with each merchant server 140 via the service provider 180 over the network 160.

In various embodiments, each of the one or more business entities having a related merchant server 140 may need to establish at least one merchant account with the service provider 180. When establishing a merchant account, each of the one or more business entities may need to provide business information, such as owner name, owner address, social security number, date of birth, phone number, email address, etc., and financial information, such as banking information, merchant account information, credit card information, payment processing information, etc.

In one embodiment, each merchant device 140 includes at least one network interface component (NIC) 152 adapted for communication with the network 160. For example, in various implementations, the network interface component 152 may comprise a wireless communication component, such as a mobile cellular component, a wireless broadband component, a wireless satellite component, or various other types of wireless communication components including radio frequency (RF), microwave frequency (MWF), and/or infrared frequency (IRF) components adapted for communication with the network 160. In various other implementations, the network interface component 152 may be adapted to interface with a DSL (e.g., Digital Subscriber Line) modem, a PSTN (Public Switched Telephone Network) modem, an Ethernet device, and/or various other types of wired and/or wireless network communication devices adapted for communication with the network 160.

In one embodiment, each merchant device 140 may comprise a printing component to print an invoice having an invoice identifier. In various implementations, the printing component may comprise various types of printers, such as an ink jet printer, a laser printer, a copy machine printer, or various other generally known printing devices.

The service provider 180, in one embodiment, may be maintained by a network based transaction processing entity, which may provide processing for network based transactions including online information and/or financial transactions on behalf of the user via the user device 120 and/or each merchant device 140. As shown in FIG. 1, the service provider 180 includes a service interface application 182, which may be adapted to interact with the user device 120 and/or each merchant 140 over the network 160 to facilitate electronic commerce including processing payment reconciliation. In one example, a financial transaction may include the selection, purchase, and/or payment of items, products, and/or services by the user via the user device 120 from one or more merchant devices 140. In another example, a financial transaction may include reconciliation of invoice payments by the user via the user device 120 in cooperation with one or more merchant devices 140. In one embodiment, the service provider 180 may be provided by network based transaction processing entity, such as PayPal, Inc. and/or eBay of San Jose, Calif., USA.

The service interface application 182, in various embodiments, is adapted to utilize a processing module 184 and invoice reconciliation module 186 to process invoice payments and invoice reconciliation for financial transactions between the user device 120 and each merchant device 140. In various implementations, the processing module 184 and invoice reconciliation module 186 are adapted to resolve and/or reconcile financial transactions through validation, delivery, and settlement. For example, the service interface application 182 in conjunction with the processing module 184 and invoice reconciliation module 186 is adapted to settle and/or reconcile indebtedness on behalf of a user between the user device 120 and each merchant device 140, wherein accounts may be directly and/or automatically debited and/or credited, respectively, of monetary funds in a manner as accepted by the banking industry. In one embodiment, the service provider 180 comprises the printing component 196 to print an invoice having an invoice identifier. In various implementations, the printing component 196 may comprise various types of printers, such as an ink jet printer, a laser printer, a copy machine printer, or various other generally known printing devices.

In one embodiment, the service interface application 182 of the service provider 180 is adapted to generate an invoice having an invoice identifier on behalf of each merchant device 140, wherein the invoice having the invoice identifier is related to a network based financial transaction between the merchant 140 and the user of the user device 120. The service interface application 182 is adapted to communicate with the printing component 196 to print the invoice having the invoice identifier. The service interface application 182 is adapted to prepare the invoice having the invoice identifier for postal delivery to the user of the user device 120. The invoice having the invoice identifier may then be mailed to an address of the user (e.g., home address, business address, or some other address related to the user) by the service provider 180 via a postal delivery service, such as USPS, UPS, FedEx, etc. Accordingly, the service provider 180 is adapted to generate, print, and send an invoice having an invoice identifier to the user of the user device 120 of behalf of the merchant 140 for invoice payment reconciliation of a network based financial transaction between the user of the user device 120 and the merchant 140.

The service interface application 182, in various embodiments, is adapted to utilize the invoice reconciliation module 186 to resolve and/or reconcile user related invoices on behalf of the user via the user device 120. In one implementation, an invoice comprises a ledger or record of funds owed to at least one of the merchants 140 and/or service provider 180 having a state that may be stored and/or accessed using a link, such as an invoice URL link, and/or located via information stored as part of a coded message, such as information stored as part of a one-dimensional (1D) bar code, two-dimensional (2D) barcode, in a URL, or as part of some other coded message. In one aspect, the invoice may reference a checkout or purchase transaction between the user and at least one merchant 140. In another aspect, selecting (e.g., clicking on) an invoice link or invoice URL may prompt the user to input an invoice code (e.g., bar code) or an image representative of the invoice code associated with a particular invoice. Upon selection, the user may be directed to a login page provided by the service provider 180, and the user may login to the service provider 180 to review one or more invoices or invoice pages related to the inputted invoice URL and/or invoice code.

In one implementation, a unique URL with a unique invoice code may be generated by one of the merchants 140 or the service provider 180 when a user is involved in a network based financial transaction with one of the merchants 140. In one aspect, an invoice URL and/or invoice identifier code may be used once and only once for payment reconciliation for a particular financial transaction between the user and one of the merchants 140. In another aspect, the invoice may comprise a persistent invoice that is updated on a timely basis, such as daily, monthly, bi-monthly, annually, semi-annually, etc. The invoice URL and/or invoice identifier code may be valid for any amount of time until the invoice is paid, settled, and/or reconciled, without departing from the scope of the present disclosure. As such, in one aspect, the invoice reconciliation module 186 provides a mechanism for the user to access an invoice of indebtedness by selecting the invoice URL and/or providing an invoice identifier code as input (e.g., an image of the invoice and/or invoice identifier code) for a particular invoice. In another aspect, the invoice reconciliation module 186 provides a mechanism for the user to provide payment for one or more invoices based on the invoice URL and/or invoice identifier code, which is provided to the user through the network 160 or via a postal service for payment reconciliation, which is described in greater detail herein.

In one implementation, the invoice reconciliation module 186 may be adapted to coordinate with a notification module 188 to alert or remind the user to pay or reconcile one or more invoices with the service provider 180. The user may be alerted when one or more invoices are made available by the merchants 140 and/or the service provider 180 for review, due, past due, and/or any other generally acceptable reason. In another implementation, the invoice reconciliation module 186 may be adapted to share, broadcast, and/or publish the invoice URL and/or invoice identifier code to other users on the network 160. For example, if the invoice is a shared expense, the user may choose to notify (e.g., email, tweet, text, voice message, etc.) other users about the invoice so that individual user may reconcile a portion of the invoice separately with the service provider 180.

Accordingly, in various embodiments, the invoice reconciliation module 186 is adapted to automate payments, settlements, and/or reconciliations for one or more invoices by utilizing a unique invoice URL and/or a unique invoice identifier code. The service provider 180 is adapted to process the unique invoice URL and/or the unique invoice identifier code for a particular invoice on behalf of a user via the user device 120 and a merchant via one of the merchant devices 140. In one aspect, the unique invoice URL and/or the unique invoice identifier code may be mapped to a particular invoice that is stored by the service provider 180 in an account associated with the user and/or a merchant.

In one implementation, the user or payer utilizes the image capture component 130 (e.g., digital camera, cell phone camera, mobile camera, or other invoice code reader) of the user device 120 to capture the image 136 of an invoice URL and/or an invoice identifier code, which is representative of a particular invoice. The user interface application 122 is adapted to obtain the invoice URL and/or the invoice identifier code from the image 136 and fetch invoice information related to the invoice URL and/or the invoice identifier code from the service provider 180 via the network 160. In one implementation, the invoice URL and/or the invoice identifier code may refer to a particular invoice and/or particular invoice information related to a particular invoice, such as invoice description, product description, amount due, due date, user identity, user account, merchant identity, merchant account, etc).

The user interface application 122, in one embodiment, is adapted to display invoice information to the user or payer via the user device 120. The user or payer may choose to pay, settle, and/or reconcile the invoice immediately, choose to schedule a payment, choose a form of payment (e.g., account balance, bank account, credit card, etc.), and/or confirm invoice payment. In one aspect, the user or payer may pay one or more invoices within a short time period (e.g., minutes) using a mobile communication device (e.g., mobile phone) to achieve an experience that is faster, more efficient, and less error prone than conventional methods, such as submitting a personal check via mail delivery. These and other aspects of the present disclosure are described in greater detail herein.

The service interface application 182, in one embodiment, is adapted to utilize the notification module 188, which is adapted to notify users to pay or reconcile one or more invoices with the service provider 180. The user may be alerted when one or more invoices are available for review, due, past due, and/or any other generally acceptable reason. In one implementation, the service interface application 182 in combination with the notification module 188 is adapted to notify or alert users of new, pending, and/or due invoices with notifications or alerts (e.g., email message, text message, voice message, etc.), which may include one or more selectable links (e.g., invoice URLs) to access particular invoices and/or invoice identifier codes to reference particular invoices via image capture of the invoice URLs and/or invoice identifier codes, as provided herein. In another implementation, if the user captures an image of a particular invoice URL and/or invoice identifier code in the notification or alert, then the user may review one or more invoices and request processing of selected invoices by the processing module 184.

The service application 182, in one embodiment, may be adapted to utilize a selection processing module to process and monitor user selection events during online shopping by the user via the user device 120. In one aspect, the selection processing module allows the service provider 180 to process and monitor user selections during online navigation and shopping events over the network 160. For example, the service provider 180 interfaces with the user device 120 via, e.g., a browser window to monitor the user and the user device 120 during navigation and shopping events on various merchant sites. The selection processing module may be used by the service provider 180 to monitor user selections of one or more items, products, and/or services and store navigation history as part of a user account.

The service provider 180, in one embodiment, may be configured to maintain one or more user accounts and merchant accounts in an account database 190, each of which may include account information 192 associated with one or more individual users and one or more merchants 140. For example, account information 192 may include private financial information of the user and each merchant 140, such as one or more account numbers, passwords, credit card information, banking information, or other types of financial information, which may be used to facilitate online financial transactions between the user and the one or more merchant devices 140. In various implementations, the methods and systems described herein may be modified to accommodate additional users and/or additional merchants that may or may not be associated with at least one existing user account and/or merchant account, respectively.

In one implementation, the user and/or user device 120 may have identity attributes stored with the service provider 180 as the user identifier 130, and the user and/or user device 120 may have credentials to authenticate or verify identity with the service provider 180. In one aspect, user attributes may include personal information and/or banking information, as previously described. In other aspects, the user attributes may be passed to the service provider 180 as part of a login and/or transaction request, and the user attributes may be utilized by the service provider 180 to associate the user and/or the user device 120 with one or more particular user accounts in the account database 190 maintained by the service provider 180. In still other aspects, user related invoices including invoice URLs and/or invoice identifier codes may be stored and maintained by the service provider 180 in the account database 190 as part of user accounts related to particular users.

In another implementation, each of the merchants and/or merchant devices 140 may have identity attributes stored with the service provider 180 as merchant identifiers 150, and each of the merchant devices 140 may have credentials to authenticate or verify identity with the service provider 180. In one aspect, merchant attributes may include business information and/or banking information, as previously described. In other aspects, the merchant attributes may be passed to the service provider 180 as part of a login and/or transaction request, and the merchant attributes may be utilized by the service provider 180 to associate each of the merchant devices 140 with one or more merchant accounts in the account database 190 maintained by the service provider 180. In still other aspects, merchant related invoices including invoice URLs and/or invoice identifier codes may be stored and maintained by the service provider 180 in the account database 190 as part of merchant accounts related to particular merchants.

The service provider 180, in various embodiments, may include a network interface component (NIC) 194 adapted for communication with the network 160 and any network based communication devices including the network interface component 132 of the user device 120 and the network interface component 152 of each merchant 140. In various implementations, the network interface component 194 of the service provider 180 may include a wireless communication component, such as a wireless broadband component, a wireless satellite component, or various other types of wireless communication components including radio frequency (RF), microwave frequency (MWF), and/or infrared frequency (IRF) components adapted for communication with the network 160. In other various implementations, the network interface component 152 may be adapted to interface with a DSL (e.g., Digital Subscriber Line) modem, a PSTN (Public Switched Telephone Network) modem, an Ethernet device, and/or various other types of wired and/or wireless network communication devices adapted for communication with the network 160.

The service provider 180, in various embodiments, may include one or more other databases 198 (e.g., internal and/or external databases) for storing and tracking information related to financial transactions including invoice payment reconciliation between particular users, such as a user of user device 120, the one or more merchant devices 140, and the service provider 180. In one implementation, the databases 198 may provide a historical survey of transactions including invoice payment reconciliations between the user device 120, the one or more merchant devices 140, and the service provider 180. For example, the service interface application 182 may be adapted to monitor, track, log, and store transaction information related to network based electronic commerce including invoice payment reconciliation between the user device 120, each merchant 140, and/or the service provider 180, and the stored transaction information is accessible from the databases 198 for analysis, maintenance, settlement, and reconciliation.

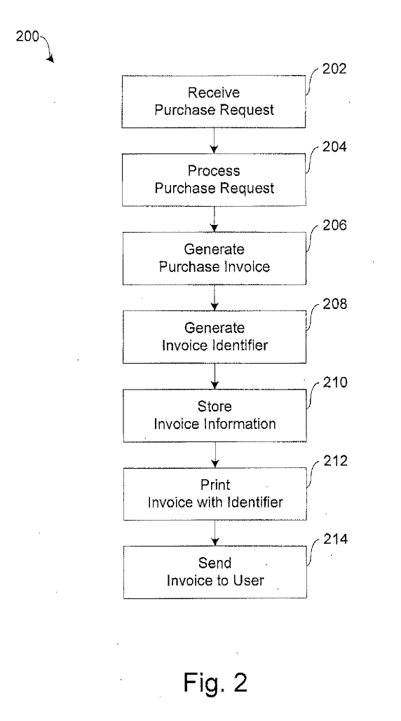

FIG. 2 shows one embodiment of a method 200 for facilitating electronic commerce including facilitating payment reconciliation over the network 160. It should be appreciated that, for purposes of explanation, the method 200 of FIG. 2 is described in reference to the system 100 of FIG. 1, but should not be limited thereto.

In one embodiment, in reference to a financial transaction over the network 160, the service provider 180 may generate or create an invoice having an invoice identifier, such as an invoice URL and/or an invoice identifier code, on behalf of at least one merchant 140. In one implementation, as described herein, the invoice identifier references a particular invoice representative of a financial transaction between a user and a merchant, wherein the merchant utilizes the service provider 180 as a payment reconciliation provider to resolve or reconcile payments through validation, delivery, and settlement.

Referring to FIG. 2, the service provider 180 is adapted to receive a purchase request from either a user via the user device 120 or one of the merchants via one of the merchant devices 140 over the network 160 (block 202). For example, a user or buyer may visit an online merchant website and navigate through the merchant's products and pages to select one or more items for purchase. The selected items are placed in a virtual shopping cart until checkout. When the user is done shopping, the user accesses a merchant webpage for viewing the selected items in the virtual shopping cart. The user may decide to checkout (i.e., purchase) and request processing of the purchase transaction. Upon user instruction, the service provider 180 receives a purchase request from either the user via the user device 120 or the merchant via the merchant device 140 over the network 160 in reference to the shopping cart and the one or more items selected for purchase. In one aspect, the purchase request may include information related to the transaction including user name, user account, merchant name, merchant account, and one or more items selected for purchase including item description, price, weight, size, etc.

The service provider 180 is adapted to process the received purchase request (block 204), generate a purchase invoice (block 206), and generate an invoice identifier for the purchase invoice (block 208). For example, the merchant via the merchant device 140 is adapted to request generation of the purchase invoice from the service provider 180. As part of generating the purchase invoice, an invoice identifier is generated that references the purchase invoice and/or information associated therewith. In one aspect, the invoice identifier comprises an invoice URL or an invoice identifier code (e.g., a 2D bar code) that includes a link (via a unique token) to the account database 190 of the service provider 180 where the invoice information related to the generated invoice is stored. In another aspect, the invoice identifier comprises an invoice URL and/or an invoice identifier code (e.g., a 2D bar code) that encodes information related to the generated invoice. The invoice information may include one or more of user name as payer, user account, merchant name, merchant account, addresses, purchase amount, and one or more items selected for purchase including item description, price, weight, size, etc.

Referring to FIG. 2, the merchant via the merchant device 140 and/or the service provider 180 are adapted to store information related to the purchase invoice (block 210). In one implementation, user information (e.g., attributes related to the user including user name and account number), merchant information (e.g., merchant name, merchant account, and the one or more items selected for purchase), and other information related to the invoice including the invoice identifier may be stored as part of a user account and/or a merchant account in the account database 190 of the service provider 180.

The purchase invoice is printed with the invoice identifier as part thereof (block 212), and the printed invoice with the invoice identifier is sent to the user (block 214). In one implementation, the service provider 180 is adapted to print the purchase invoice with the printing component 196 and mail the printed invoice with the invoice identifier to the user or payer via a mail service, such as the USPS, UPS, FedEx, etc. The invoice having the invoice identifier may be mailed to an address of the user (e.g., home address, business address, or some other address related to the user) by the service provider 180 via the postal delivery service. Accordingly, the service provider 180 is adapted to generate, print, and send an invoice having an invoice identifier to the user of the user device 120 of behalf of the merchant 140 for invoice payment reconciliation of a network based financial transaction between the user of the user device 120 and the merchant 140.

In another implementation, the merchant via the merchant device 140 may be adapted to print the purchase invoice and mail the printed purchase invoice with the invoice identifier to the user or payer via a mail service, such as the USPS, UPS, FedEx, etc. In either implementation, both the merchant 140 and the service provider 180 may store, track, and/or manage invoice information including the invoice identifier for payment reconciliation. In one aspect, the printed invoice includes the invoice identifier, such as a URL, a 2D bar code, or some other encoding mechanism.

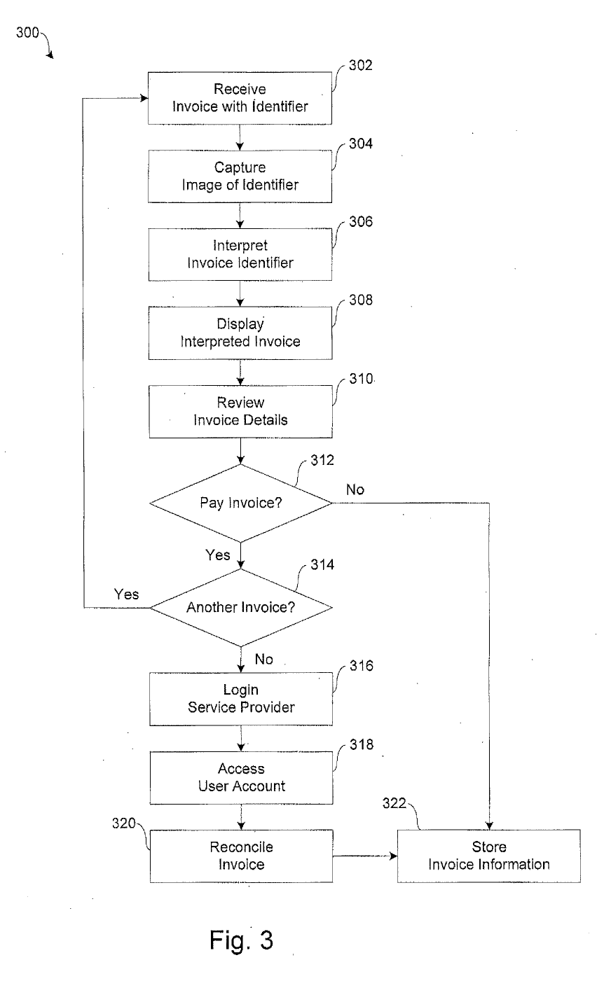

FIG. 3 shows one embodiment of a method 300 for facilitating electronic commerce including facilitating payment reconciliation over the network 160. It should be appreciated that, for purposes of explanation, the method 300 of FIG. 3 is described in reference to the system 100 of FIG. 1, but should not be limited thereto.

In one embodiment, in reference to a financial transaction over the network 160, a user of the user device 120 may request payment and reconciliation for an invoice having an invoice identifier, such as an invoice URL and/or an invoice identifier code. As described herein, the invoice identifier references a particular invoice representative of a financial transaction between a user and a merchant, wherein the merchant utilizes the service provider 180 as a payment reconciliation provider to resolve or reconcile payments through validation, delivery, and settlement.

Referring to FIG. 3, the user receives one or more invoices with each invoice having an invoice identifier from either the service provider 180 or one or more of the merchants 140 (block 302). For example, in reference to an invoice for a purchase transaction over the network 160, the user is the payer of the one or more received invoices. The user or payer receives the invoice in the mail, which is delivered by a mail delivery service, such as USPS, UPS, FedEx, or some other mail delivery service.

In one aspect, the user or buyer may visit an online merchant website and navigate through the merchant's products and pages to select one or more items for purchase. When the user is done shopping, the user may checkout (i.e., purchase) and request processing of the purchase transaction. Upon user instruction, the service provider 180 receives a purchase request from either the user via the user device 120 or the merchant via the merchant device 140 over the network 160 and generates an invoice with an invoice identifier in reference to the shopping cart and the one or more items selected for purchase, in a manner as described in reference to method 200 of FIG. 2. In one aspect, as described herein, the invoice identifier includes information related to the invoice including user name of the user or payer, user account, merchant name, merchant account, and one or more items selected for purchase including item description, price, weight, size, etc.

Referring to FIG. 3, if the user or payer elects to pay the invoice electronically, then the user may capture an image of the invoice identifier as provided on the received invoice (block 304). For example, in one implementation, the user may utilize the user device 120 to capture an image of the invoice identifier with the image capture component 126 (e.g., a digital camera). As such, in one aspect, the user or payer may take a picture (e.g., digital image) of the invoice identifier with a mobile phone via an integrated digital camera.

Upon user instruction, the user interface application 122 may receive the captured image of the invoice identifier from the image capture component 126, utilize the invoice translation module 124 to analyze the captured image and interpret the invoice identifier (block 306) to obtain invoice information, and display the interpreted invoice with the invoice information to the user (block 308) on the user device 120 to thereby allow the user to review the invoice with invoice details (block 310), in a manner as originally entered by the merchant. As such, in one aspect, the user interface application 122 on the user's mobile phone may be utilized to decode invoice information as provided by the invoice identifier code, such as a 2D bar code. In another aspect, if the invoice identifier comprises an invoice URL, then the user interface application 122 may access the service provider 180 via the network 160 and fetch invoice information related to the invoice that is stored in the account database 190 of the service provider 180. The user interface application 122 may then utilize the invoice translation module 124 to electronically display (block 308) the invoice to the user via the user device 120 to thereby allow the user to review the invoice with invoice details (block 310), in a manner as originally entered by the merchant.

Referring to FIG. 3, the user or payer may choose to pay the invoice electronically over the network 160 (block 312). If the user decides to pay the invoice, then the user may select another invoice to review (block 314), and the process 300 repeats blocks 302 to 312 for each selected invoice. If the user decides not to pay the invoice, then the user may choose to store the invoice information (block 322) in the user device 120 for later payment. For example, in one implementation, the user or payer may choose to pay the invoice via their mobile phone or take another picture of another invoice and pay all the invoices at once. As such, the user or payer may choose to pay multiple invoices electronically, which may be considered faster than payment by check, and the user or payer may store, track, and manage invoice details and invoice payments online via the network 160.

Referring to FIG. 3, once the user or payer decides not to select another invoice for payment (block 314), the user or payer may login to the service provider 180 via the user device 120 over the network 160 (block 316) and access a user account related to the user (block 318). In one aspect, the user logs in to the service provider 180 with an intention to provide payment for the one or more invoices selected for payment reconciliation. In another aspect, the user may submit an invoice payment request to the service provider 180 before or after login. The invoice payment request may be sent to the service provider 180 via the user device 120 over the network 160. The invoice payment request may include an image of the invoice and/or the invoice identifier. The invoice payment request may include one or more images of one or more invoices and/or one or more invoice identifiers. As such, in various implementations, the user via the user device 120 over the network 160 may provide the service provider 180 with one or more images of one or more invoices and/or one or more invoice identifiers for invoice payment reconciliation, as described herein.

In one implementation, the service provider 180 is adapted to receive user identity information from the user via the user device 120 over the network 160. In one aspect, user identity information may include attributes related to the user, such as personal information of the user (e.g., usernames, passwords, photograph images, biometric ids, addresses, phone numbers, etc.) and banking information (e.g., banking institutions, credit card issuers, user account numbers, security information, etc.). The service provider 180 is adapted to verify a user account related to the user in the account database 190 based on user information passed from the user device 120 over the network 160.

In another implementation, the service provider device 180 processes a user login request by attempting to locate and access a user account related to the user in the account database 190. If the user is determined to be an existing user by the service provider 180, then the service provider 180 is adapted to verify the user account and user identity information provider by user 102 in the user login request by comparing the received user information with account information 192 stored as part of the user account in the account database 190. In one aspect, the service provider 180 may determine if the user account is current and active. In some instances, user account information may need to be updated, and as such, the service provider device 180 may prompt the user 102 to update user account information 188 in the user account for the user.

It should be appreciated by those skilled in the art that the service provider 180 may cancel the user login request at any time during the process of method 200 if, for example, it is determined by the service provider 180 that the user enters wrong information or the user is trying to access an account with criminal intent.

Referring to FIG. 3, the user provides payment for the one or more invoices selected for payment reconciliation (block 320). In one implementation, the service provider 180 is adapted to prompt the user to complete payment reconciliation from the user device 120 over the network 160. For example, in one aspect, the service provider 180 may prompt the user via the user device 120 to select a permission button to settle, resolve, or reconcile invoice debt with funds in the user account, which may be transferred from the user account to an account related to the merchant.

After payment reconciliation, the user may choose to store invoice information (block 322) in the user device 120. For example, in one aspect, user information (e.g., attributes related to the user including user name and account number), merchant information (e.g., merchant name, merchant account, and the one or more items selected for purchase), and other invoice information including the invoice identifier related to the invoice may be stored in a memory component of the user device 120.

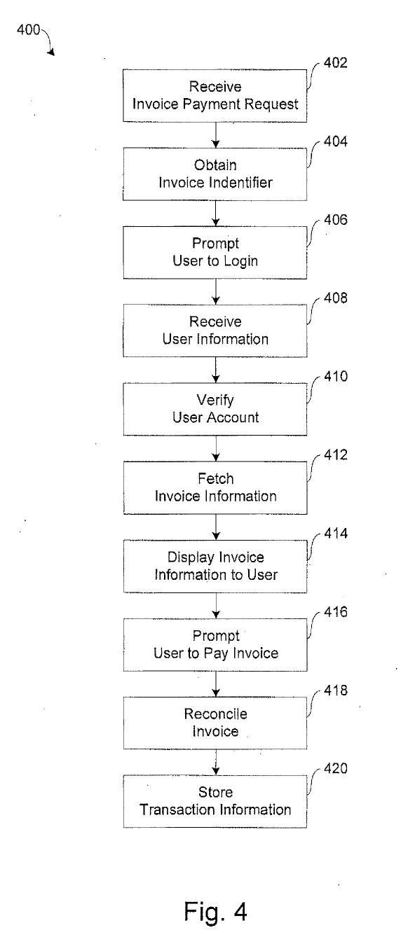

FIG. 4 shows one embodiment of a method 400 for facilitating electronic commerce including facilitating payment reconciliation over the network 160. It should be appreciated that, for purposes of explanation, the method 400 of FIG. 4 is described in reference to the system 100 of FIG. 1, but should not be limited thereto.

Referring to FIG. 4, the service provider 180 is adapted to receive an invoice payment request from a user via the user device 120 over the network 160 (block 402). For example, the user or payer may access the service provider 180 over the network 160 to provide payment for an invoice received from at least one merchant 140 or the service provider 180 via the mail, such as USPS, UPS, FedEx, or some other postal service. In one aspect, the invoice payment request includes information related to an invoiced purchase transaction between the user and at least one merchant 140.

In one implementation, the service provider 180 receives the invoice payment request from the user via the user device 120 over the network 160. The invoice payment request may include an image of the invoice and/or the invoice identifier. The invoice payment request may include one or more images of one or more invoices and/or one or more invoice identifiers. As such, in various implementations, the service provider 180 may receive the invoice payment request from the user via the user device 120 over the network 160, wherein the invoice payment request includes one or more images of one or more invoices and/or one or more invoice identifiers for invoice payment reconciliation.

Referring to FIG. 4, the service provider 180 is adapted to obtain the invoice identifier from the invoice payment request (block 404). For example, as part of generating the purchase invoice, an invoice identifier is generated that references the purchase invoice and/or information associated therewith. In one aspect, the invoice identifier comprises an invoice URL or an invoice identifier code (e.g., a 2D bar code) that includes a link (via a unique token) to the account database 190 of the service provider 180 where the invoice information related to the generated invoice is stored. In another aspect, the invoice identifier comprises an invoice URL and/or an invoice identifier code (e.g., a 2D bar code) that encodes information related to the generated invoice. The invoice information may include one or more of user name as payer, user account, merchant name, merchant account, addresses, purchase amount, and one or more items selected for purchase including item description, price, weight, size, etc.

The service provider 180 is adapted to prompt the user to login from the user device 120 over the network 160 (block 406). In one aspect, the user is logging in to the service provider 180 with an intention to reconcile the invoice from the at least one merchant 140 as provided in the received invoice payment request.

The service provider 180 is adapted to receive user information, such as identity information, from the user via the user device 120 over the network 160 (block 408). In one aspect, user identity information may include attributes related to the user, such as personal information related to the user (e.g., usernames, passwords, photograph images, biometric ids, addresses, phone numbers, etc.) and/or banking information (e.g., banking institutions, credit card issuers, user account numbers, security information, etc.).

The service provider 180 is adapted to verify a user account related to the user in the account database 190 based on user information passed from the user device 120 over the network 160 (block 410). In one implementation, the service provider device 180 processes a user login request by attempting to locate and access an account related to the user in the account database 190. If the user is determined to be an existing user by the service provider 180, then the service provider 180 is adapted to verify the user account and user identity information provider by user 102 in the user login request by comparing the received user information with account information 192 stored as part of the user account in the account database 190. In one aspect, the service provider 180 may determine if the user account is current and active. In some instances, user account information may need to be updated, and as such, the service provider device 180 may prompt the user 102 to update user account information 188 in the user account for the user.

It should be appreciated by those skilled in the art that the service provider 180 may cancel the user login request at any time during the process of method 200 if, for example, it is determined by the service provider 180 that the user enters wrong information or the user is trying to access an account with criminal intent.

Referring to FIG. 4, the service provider 180 is adapted to fetch information related to the invoice as referenced by the invoice identifier (block 412). In one aspect, the service provider 180 is adapted to fetch invoice information related to the invoice as referenced by invoice identifier that is stored in the account database 190 of the service provider 180. The service provider 180 may then utilize the invoice translation module 124 to electronically display (block 414) the invoice to the user via the user device 120 to thereby allow the user to review the invoice with invoice details, in a manner as originally entered by the at least one merchant 140.

Referring to FIG. 4, the service provider 180 is adapted to prompt the user to pay the invoice from the user device 120 over the network 160 (block 416). For example, in one implementation, the service provider 180 may prompt the user via the user device 120 to select a permission button to settle the debt with funds in the user account, which may be transferred from the user account to an account related to the merchant 140. At this point, the user or payer may choose to pay the invoice electronically over the network 160 via the user device 120, and the service provider 180 reconciles the invoice payment (block 418). In one implementation, the service provider 180 is adapted to settle, resolve, or reconcile invoice debt with funds in the user account, which may be transferred from the user account to an account related to the merchant 140. However, in another aspect, the user may choose to utilize another form of payment to settle, resolve, or reconcile the debt, such as a credit card, debit card, electronic fund transfer (EFT), etc.

The service provider 180 is adapted to store transaction information related to the invoice payment reconciliation (block 420). In one aspect, user information (e.g., attributes related to the user including user name and account number), merchant information (e.g., merchant name, merchant account, and the one or more items selected for purchase), and other transaction information related to the incomplete transaction may be stored as part of the user account and/or the merchant account in the account database 190 so that the user and/or merchant may review the reconciliation history.

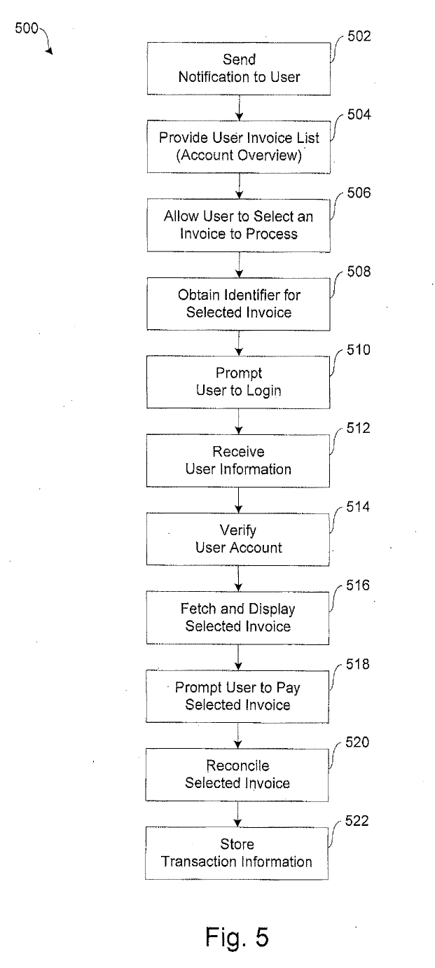

FIG. 5 shows one embodiment of a method 500 for facilitating electronic commerce including facilitating payment reconciliation over the network 160. It should be appreciated that, for purposes of explanation, the method 500 of FIG. 5 is described in reference to the system 100 of FIG. 1, but should not be limited thereto.

Referring to FIG. 5, the service provider 180 is adapted to send notification of one or more pending invoice payments to a user via the user device 120 over the network 160 (block 502). In various implementations, the user may be notified via notification by email, alert, text message, voice message, postal mail, etc. For example, a user may be notified of one or more pending invoice payments via an email notification. In another example, a user may be notified of one or more pending invoice payments via an alert notification having an account overview from the service provider 180.

The service provider 180 is adapted to provide the user with a list of one or more pending invoice payments via the user device 120 over the network 160 (block 504). In various examples, the list of pending invoice payments may comprise an interactive list having selectable links to pending invoice payments. For example, when a user is notified of one or more pending invoice payments via an email notification, a list of pending invoice payments may comprise an interactive list having one or more selectable links related to one or more corresponding pending invoice payments. In another example, when a user is notified of one or more pending invoice payments via an alert notification from the service provider 180, the alert notification includes an account overview having a list of pending invoice payments that may comprise an interactive list having one or more selectable links related to one or more corresponding pending invoice payments.

Referring to FIG. 5, the service provider 180 is adapted to allow the user to select one or more pending invoice payments from the list to process via the user device 120 over the network 160 (block 506). For instance, the user may review a notification and choose to pay a pending invoice by selecting a selectable link related to a corresponding invoice.

Referring to FIG. 5, the service provider 180 obtains the invoice identifier for the selected invoice (block 508). In one aspect, each pending invoice in the list may include a corresponding invoice identifier associated with a particular invoice. The invoice identifier may include a selectable URL link that is provided with each invoice identifier.

The service provider 180 prompts the user to login from the user device 120 over the network 160 (block 510), receive user information, such as identity information, from the user via the user device 120 over the network 160 (block 512), and verify a user account related to the user in the account database 190 based on user information passed from the user device 120 over the network 160 (block 514).

The service provider 180 is adapted to fetch and display invoice information of the invoice selected by the user from the user device 120 over the network 160 (block 516) and prompt the user to pay the selected invoice (block 518). In one aspect, the service provider 180 is adapted to fetch invoice information related to the invoice as referenced by invoice identifier that is stored in the account database 190 of the service provider 180. The service provider 180 may then utilize the invoice translation module 124 to electronically display the invoice to the user via the user device 120 to thereby allow the user to review the invoice with invoice details, in a manner as originally entered by the merchant 140. In another aspect, the service provider 180 may prompt the user via the user device 120 to select a permission button to settle the debt with funds in the user account, which may be transferred from the user account to an account related to the merchant 140.

At this point, the user or payer may choose to pay the invoice electronically over the network 160 via the user device 120, and the service provider 180 reconciles the invoice payment (block 520). In one implementation, the service provider 180 is adapted to settle, resolve, or reconcile invoice debt with funds in the user account, which may be transferred from the user account to an account related to the merchant 140. However, in another aspect, the user may choose to utilize another form of payment to settle, resolve, or reconcile the debt, such as a credit card, debit card, electronic fund transfer (EFT), etc.

The service provider 180 is adapted to store transaction information related to the invoice payment reconciliation (block 522). In one aspect, user information (e.g., attributes related to the user including user name and account number), merchant information (e.g., merchant name, merchant account, and the one or more items selected for purchase), and other transaction information related to the incomplete transaction may be stored as part of the user account and/or the merchant account in the account database 190 so that the user and/or merchant may review the reconciliation history.

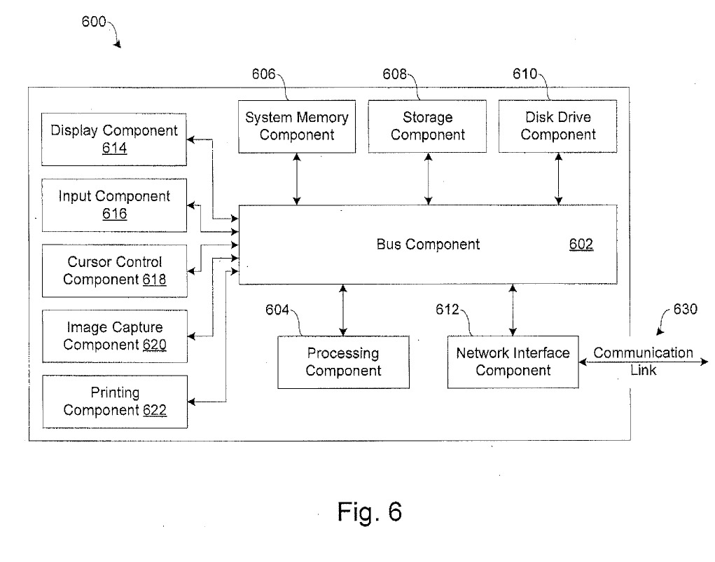

FIG. 6 is a block diagram of a computer system 600 suitable for implementing various embodiments of the present disclosure, including the user device 120, the merchant devices 140, and the service provider device 180. In various implementations, the user device 120 may comprise a network communication device (e.g., mobile cellular phone, laptop, personal computer, etc.) capable of communicating with the network 160, the merchant devices 140 may comprise a network computing device (e.g., a network server), and the service provider device 180 may comprise a network computing device (e.g., a network server). In other implementations, it should be appreciated that the merchant devices 140 and the service provider device 180 may comprise a network communication device (e.g., mobile cellular phone, laptop, personal computer, etc.) capable of communicating with the network 160, without departing from the scope of the present disclosure. Hence, it should be appreciated that each of the devices 120, 140, 180 may be implemented as the computer system 600 for communication with the network 160 in a manner as follows.

In accordance with various embodiments of the present disclosure, computer system 600, such as a mobile communication device and/or a network server, includes a bus 602 or other communication mechanism for communicating information, which interconnects subsystems and components, such as processing component 604 (e.g., processor, micro-controller, digital signal processor (DSP), etc.), system memory component 606 (e.g., RAM), static storage component 608 (e.g., ROM), disk drive component 610 (e.g., magnetic or optical), network interface component 612 (e.g., modem or Ethernet card), display component 614 (e.g., CRT or LCD), input component 616 (e.g., keyboard), cursor control component 618 (e.g., mouse or trackball), image capture component 620 (e.g., analog or digital camera), and printing component 622 (e.g., ink jet printer, laser printer, photo printer, copy machine printer, etc.). In one implementation, disk drive component 610 may comprise a database having one or more disk drive components.

In accordance with embodiments of the present disclosure, computer system 600 performs specific operations by processor 604 executing one or more sequences of one or more instructions contained in system memory component 606. Such instructions may be read into system memory component 606 from another computer readable medium, such as static storage component 608 or disk drive component 610. In other embodiments, hard-wired circuitry may be used in place of or in combination with software instructions to implement the present disclosure.

Logic may be encoded in a computer readable medium, which may refer to any medium that participates in providing instructions to processor 604 for execution. Such a medium may take many forms, including but not limited to, non-volatile media and volatile media. In various implementations, non-volatile media includes optical or magnetic disks, such as disk drive component 610, and volatile media includes dynamic memory, such as system memory component 606. In one aspect, data and information related to execution instructions may be transmitted to computer system 600 via a transmission media, such as in the form of acoustic or light waves, including those generated during radio wave and infrared data communications. In various implementations, transmission media may include coaxial cables, copper wire, and fiber optics, including wires that comprise bus 602

Some common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, carrier wave, or any other medium from which a computer is adapted to read.

In various embodiments of the present disclosure, execution of instruction sequences to practice the present disclosure may be performed by computer system 600. In various other embodiments of the present disclosure, a plurality of computer systems 600 coupled by communication link 630 (e.g., network 160 of FIG. 1, such as a LAN, WLAN, PTSN, and/or various other wired or wireless networks, including telecommunications, mobile, and cellular phone networks) may perform instruction sequences to practice the present disclosure in coordination with one another.

Computer system 600 may transmit and receive messages, data, information and instructions, including one or more programs (i.e., application code) through communication link 630 and communication interface 612. Received program code may be executed by processor 604 as received and/or stored in disk drive component 610 or some other non-volatile storage component for execution.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software, in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. Having thus described embodiments of the present disclosure, persons of ordinary skill in the art will recognize that changes may be made in form and detail without departing from the scope of the present disclosure. Thus, the present disclosure is limited only by the claims.

1. A system comprising:
an image sensor;
non-transitory computer readable media storing instructions; and
one or more hardware processors coupled to the non-transitory computer readable media and configured to read the instructions from the non-transitory computer readable media to cause the system to perform operations comprising:
capture data using the image sensor;
decode the data to identify a unique electronic token providing access to a database;
access the database using the unique electronic token;
retrieve information associated with an account corresponding to the unique electronic token;
generate an electronic user interface displaying the information associated with the account and a request for login information associated with the account; and
access the account in response to receiving, via the electronic user interface, login information associated with the account.

2. The system of claim 1, wherein the login information includes a biometric identifier.

3. The system of claim 1, wherein the instructions further cause the system to perform operations comprising:
store the retrieved information associated with the account in the non-transitory computer readable media.

4. The system of claim 1, wherein the database is remote from the system and connected to the system over a network.

5. The system of claim 3, wherein the information associated with the account comprises an image of an invoice.

6. The system of claim 5, wherein the instructions further cause the system to perform operations comprising:
generate an actuatable permission button for display on the electronic user interface; and
reconcile the invoice in response to receiving an actuation of the actuatable permission button.

7. The system of claim 6 wherein the instructions further cause the system to perform operations comprising:
store a merchant information in the non-transitory computer readable media after reconciling the invoice.

8. Non-transitory machine readable media having stored thereon machine-readable instructions executable to cause a machine to perform operations comprising:
associate an account in a database associated with a unique electronic token;
generate a printable identifier code with the unique electronic token embedded in the identifier code;
receive a request to access the account based on the unique electronic token embedded in a printed identifier code;
request login information in response to receiving the request to access the account;
receive login information; and
provide information associated with the account in response to receiving the login information.

9. The non-transitory machine readable media of claim 8, wherein the login information includes a biometric identifier.

10. The non-transitory machine readable media of claim 8, wherein the information associated with the account comprises an image of an invoice.

11. The non-transitory machine readable media of claim 10, wherein the instructions further cause the machine to perform operations comprising:
generate an actuatable permission button for display; and
reconcile the invoice in response to receiving an actuation of the actuatable permission button.

12. The non-transitory machine readable media of claim 11, wherein the instructions further cause the machine to perform operations comprising:
provide merchant information associated with the invoice in response to receiving the actuation of the actuatable permission button.

12. The non-transitory machine readable media of claim 11, wherein the instructions further cause the machine to perform operations comprising:
provide merchant information associated with the invoice in response to receiving the actuation of the actuatable permission button.

13. The non-transitory machine readable media of claim 11, wherein the instructions further cause the machine to perform operations comprising:
sending an electronic message including an image of the identifier code to an address associated with the account.

14. A computer implemented method, the method comprising operations of:
capturing data using with an image sensor;
decoding the data to identify a unique electronic token providing access to a database;
using the electronic token to access the database over a network;
retrieving information associated with an account corresponding to the unique electronic token;
displaying on a display an electronic user interface with the information associated with the account and a request for login information associated with the account; and
accessing the account in response to receiving from a user, via the electronic user interface, login information associated with the account

15. The method of claim 14, wherein the login information includes a biometric identifier.

16. The method of claim 14, further comprising storing the retrieved information associated with the account in memory.

17. The method of claim 14, wherein the information associated with the account comprises an image of an invoice.

18. The method of claim 14, further comprising:
generating an actuatable permission button for display on the electronic user interface; and
reconciling the invoice in response to receiving an actuation of the actuatable permission button.

19. The method of claim 14, further comprising storing a merchant information in memory after reconciling the invoice.

20. The method of claim 14, wherein the captured data is a 2D barcode.
